(19) United States
(12) Patent Application Publication
(10) Pub. No.: US 2019/0313603 A1
(43) Pub. Date: Oct. 17, 2019

(54) FEEDER ASSEMBLY

(71) Applicant: Hansen Ag Solutions, LLC, Clive, IA (US)

(72) Inventors: LLOYD D. SNELL, AMES, IA (US); DAVID MEESTER, FRESNO, CA (US)

(21) Appl. No.: 16/383,183

(22) Filed: Apr. 12, 2019

Related U.S. Application Data
(60) Provisional application No. 62/657,140, filed on Apr. 13, 2018.

(51) Int. Cl. A01K 5/02

(52) U.S. Cl. CPC A01K 5/0208; A01K 1/0017; A01K 5/0283

(57) ABSTRACT

A feeder system for feeding and nurturing livestock is presented. The feeder system improves the safety of the livestock by providing a bio-secure device for feeding livestock. The feeder system provides a means for feeding an animal confined in an area, cleaning the area, and replenishing feed without requiring removal of the animal from the confined area. The feeder system is especially adapted for an improved biosecurity livestock confinement crate and floor system.

### CROSS REFERENCE TO RELATED PATENT APPLICATION(S)

This present utility patent application claims priority to U.S. Provisional Patent Application No. 62/657,140 entitled “Improved Biosecurity Livestock Confinement Crate and Floor System” filed on Apr. 13, 2018, which is fully incorporated by reference herein.

### FIELD OF THE DISCLOSURE

This disclosure relates to feeder assembly used in agriculture and elsewhere. More specifically, and without limitation, this disclosure relates to a feeder assembly for use in feeding livestock in a bio-secure confinement.

### BACKGROUND OF THE DISCLOSURE

Feeders, or feed holders, deliver feed or fodder to cattle, hogs, and other livestock. Feeders, in the form of troughs, are well known in the art. Livestock feeders are almost always comprised of metal in the shape of a bowl or an elongated pit. Livestock troughs are commonly utilized on farms, ranches, and livestock ranches. A livestock feeder is commonly used in association with a farrowing crate.

Livestock confinement crates including, but not limited to, farrowing crates, gestational crates, sow stalls, etc. are well known in the art. Livestock confinement crates are generally comprised of metal and are used to constrain a sow or other livestock. Livestock confinement crates are commonly utilized on farms, ranches, and livestock ranches. A farrowing crate is commonly used to constrain a sow which is nursing piglets.

Sow farming confinements are the means by which producers replenish their market hogs and provide products to consumers, such as pork, bacon, gammon, and other hog protein products. Sow farming comes in a variety of forms including, but not limited to, intensive commercial farming, small scale farming, and free-range farming. In modern sow farming, a commercial farm may house thousands of hogs in climate controlled bio-security enhanced buildings.

Due to this high demand, exceeding a billion hogs annually harvested, hog production and producers must and do to become more efficient in all areas. These areas range from water usage, calories to mass conversions, equipment cost and durability, and most importantly, animal well-being.

While in a sow barn, a sow typically spends an entire life in a single building, therefore, the interactions that the sow encounters are extremely important. Generally, the main types of interactions for sows include: (1) human/handler interactions; (2) interactions with their piglets; (3) interactions with equipment including, but not limited to, livestock confinement crates such as farrowing crates; and (4) interactions between a human/handler in the feeding process. Injury or death due to equipment interactions including cuts and entrapment are important considerations in equipment design and function. Finally, systems designed to protect the herd from disease, improve human interactions, air filtration, and the minimization of disease breeding environments.

Current livestock confinement crates may restrict handler visual and physical access to the sow. Restricted access increases the potential for injury of the handler during movement and health and well-being interactions. For this reason, there is a need for an improved livestock feeder which solves these long standing problems in the art.

Other negative interactions for a sow arise from the sow's piglets. Piglets are commonly engaged with a sow for feeding/nursing purposes. But current livestock feeder assemblies require a sow to have close interaction with piglets which may lead to endangering piglets. Sows may accidentally injure or kill piglets when they are performing simple tasks such as feeding, standing, lying down, rolling over, or repositioning. With the high demand for hogs, the loss of a piglet due to a negative interaction between the sow and the piglet which results in injury or death is unacceptable. The sow/piglet interaction must provide safe zones for nursing and transition zones at the head and rear of the sow. Furthermore, the confinement crate must allow the piglets to not become trapped between the sow and the confinement equipment, either while nursing or during the sow's motions. The confinement must minimize or eliminate all sharp corners and edges and other causes of injury. Not all confinement systems, due to design and manufacturing methods, control these requirements.

A confinement sow facility most importantly must maintain a healthy environment that is bio-safe. In a modern facility, bio-safe means air filtration, waste management, and minimization of areas that promote the growth of disease. Not all confinement equipment designs eliminate the internal cavities and elements that promote disease growth. Most notably, these spaces are created by confinement equipment built of square, rectangular, or round structural tubing or pipe. Furthermore, when these hollow forms are galvanized, additional holes are required for the process to prevent structural damage. These unclosed holes allow access to the entire internal volume of the structural tubing or pipe. An internal volume that is warm, damp, wet, and inaccessible for cleaning. A perfect location for the hosting of disease and pests. The biosecurity issues are amplified when bio-wastes enter a food stream, especially a trough feeder which is continuous. Biosecurity is a chief concern when bio-waste gathers rapidly on the floors of hog farms. The labor involved in removing the bio-waste is intensive and expensive. Additionally, contaminants in a food supply can cause massive loss when large amounts of feed must be disposed of. In worst case scenarios, bio-wastes enter the feeder trough system and are undetected.

Other current livestock feeder assemblies including, but not limited to, farrowing troughs have attempted to solve these problems, but have been unsuccessful. Other feeder assemblies prove more burdensome when it comes to cleaning and refilling, are bulky, expensive, and are not bio-secure. Furthermore, current livestock feeder assemblies which have attempted to solve these problems are unforgiving to a sow as they are constructed of heavy metal bars to constrain livestock.

Current methods of fabrication for livestock feeders use various standard metal forms, such as rod, tubing, bar and plate steel. Current livestock feeders utilize these heavy materials and require a welder to weld the pieces into a front, sides, a top, and a rear panel. Furthermore, current livestock feeders utilize numerous parts welded together which are more likely to fail and require more repair and maintenance.

As provided above, current arrangements and equipment for feeding livestock are not bio-secure. Biosecurity can be defined as a preventive measure designed to reduce the risk of transmission of infectious diseases in livestock. In livestock containment areas, where many livestock are often constrained in close proximity, diseases and other complications spread rapidly. Diseases are often spread through excrement. Additionally, excrement often breeds bacteria and other harmful non bio-secure facilities.

Thus, it is a primary objective of this disclosure to provide a solution to these problems and more. This disclosure provides a bio-secure feeder system. This disclosure provides a bio-secure feeder system which has increased durability through design and manufacturing, and lower cost by utilizing more efficient manufacturing methods. This disclosure further provides a feeder system that is easy to ship and transport, easy to assemble and disassemble, requires minimal installation time in new or retrofit facilities; strong enough to support all ranges of feed; easily cleaned; eliminates or greatly reduces the ability for bio-wastes and other contaminants to enter the food supply contained within the feeder assembly; etc. Additionally, the disclosure herein solves numerous problems facing the hog confinement facilities. These problems include, but are not limited to, stability of the feeder system; rigidity and durability of the feeder system; etc.

Therefore, for all the reasons stated herein, there is a need in the art for a feeder assembly system for safely feeding and farrowing livestock in a bio-secure manner.

Thus, it is an object of the disclosure to provide a feeder assembly system that improves upon the state of the art.

Another object of the disclosure is to provide a feeder assembly system that insures facility operators are safe while interacting with the animal.

Yet another object of the disclosure is to provide a feeder assembly system that is easy to use and maintain.

Another object of the disclosure is to provide a feeder assembly system that is efficiently manufacturable.

Yet another object of the disclosure is to provide a feeder assembly system that is relatively more affordable.

Another object of the disclosure is to provide a feeder assembly system that is easy to assemble.

Yet another object of the disclosure is to provide a feeder assembly system that can be assembled and disassembled quickly.

Yet another object of the disclosure is to provide a feeder assembly system that is safe for the animal constrained within the crate.

Another object of the disclosure is to provide a feeder assembly system that is safe for the animals engaging with the feeder assembly.

Yet another object of the disclosure is to provide a feeder assembly system that works with mature or young livestock.

Another object of the disclosure is to provide a feeder assembly system that allows livestock to fit without injuring offspring.

Yet another object of the disclosure is to provide a feeder assembly system that is strong enough to support large quantities of feed.

Another object of the disclosure is to provide a feeder assembly system that is bio-secure.

Yet another object of the disclosure is to provide a feeder assembly system that reduces and/or makes it impossible for contaminants to enter the interior of the feeder.

Another object of the disclosure is to provide a feeder assembly system that can be manufactured off site.

Yet another object of the disclosure is to provide a feeder assembly system that is easy to clean.

Another object of the disclosure is to provide a feeder assembly system that is stable.

Yet another object of the disclosure is to provide a feeder assembly system that can feed large animals and withstand the forces generated by animals.

Another object of the disclosure is to provide a feeder assembly system that is resilient.

Yet another object of the disclosure is to provide a feeder assembly system that provides flexibility to accommodate livestock.

Another object of the disclosure is to provide a feeder assembly system that requires little to no tools for assembly.

Yet another object of the disclosure is to provide a feeder assembly system that reduces bacteria build-up on the feeder.

Another object of the disclosure is to provide a feeder assembly system that is easy to ship.

Yet another object of the disclosure is to provide a feeder assembly system that is light and durable.

Another object of the disclosure is to provide a feeder assembly system that can easily attach to a confinement crate or other components and/or features used in livestock farming.

Another object of the disclosure is to provide a feeder assembly system that can function as a door without blocking an egress means of a livestock within a confinement crate.

Yet another object of the disclosure is to provide a feeder assembly system that accommodates manufacturing deviations in assembly.

Another object of the disclosure is to provide a feeder assembly system that can be adapted to other primary and secondary systems.

These and other objects, features, and advantages of the disclosure will become apparent from the specification, figures and claims.

### SUMMARY OF THE DISCLOSURE

A feeder assembly system for safely feeding livestock is presented. The feeder assembly system enables utilization of high-volume manufacturing to minimize parts count, eliminates most welding, maximizes functionality, and directs labor costs during manufacturing, installation, and utilization; while maximizing robustness and functionality.

The feeder assembly system presented herein improves upon the safety of the livestock and the user(s). The feeder assembly system presented herein improves upon the biosecurity of the livestock confinement. The feeder assembly system presented herein may be utilized in association with crate wherein the crate includes a designated confinement area which houses a parent livestock. The parent livestock has access to feed from the feeder assembly system and the ability to stand or lay down. The containment area is adjoined, and separated, by the Flying-W configuration of the rib structure. This configuration protects a litter of livestock in the adjoining safety area from being injured or killed when a parent livestock stands up or lies down. The configuration is unique in that it protects the litter while still allowing the livestock to feed from the feeder assembly. The configuration is unique in that it can support heavy livestock and still provide a bio-secure feeder assembly.

The feeder assembly system is structurally sound but is also flexible due to its unique design. The feeder assembly is easy to assemble, easy to clean, and safe to use. Previous livestock feeders, such as a farrowing trough, were expensive, burdensome to assemble, and lacked biosecurity. The issues associated with livestock feeders found in the prior art have been issues in the industry for many years. The feeder assembly system and methods for assembly described herein solve these issues in the art and many more. The feeder assembly system presented herein utilizes novel components in a unique way in order to create a safe and useful feeder that can be utilized in many fields and industries including, but not limited to, the livestock industry, that can be assembled quickly and efficiently. The feeder assembly system presented herein creates a bio-secure environment which reduces contaminants in the feed which result in harmful effects on livestock.

### BRIEF DESCRIPTION OF THE DRAWINGS

FIG. 1 is a perspective view of an improved biosecurity livestock system; the view showing a feeder system; the view showing a crate;

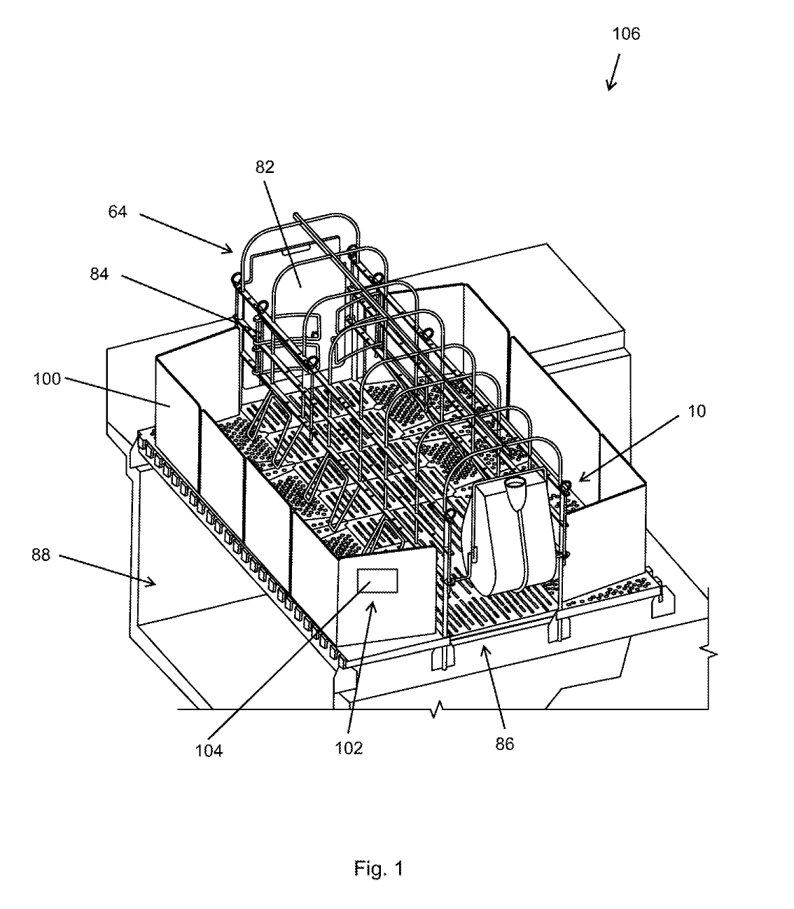

FIG. 2 is a perspective view of an improved biosecurity livestock system; the view showing a door assembly; the view showing a crate; the view showing a floor deck assembly;

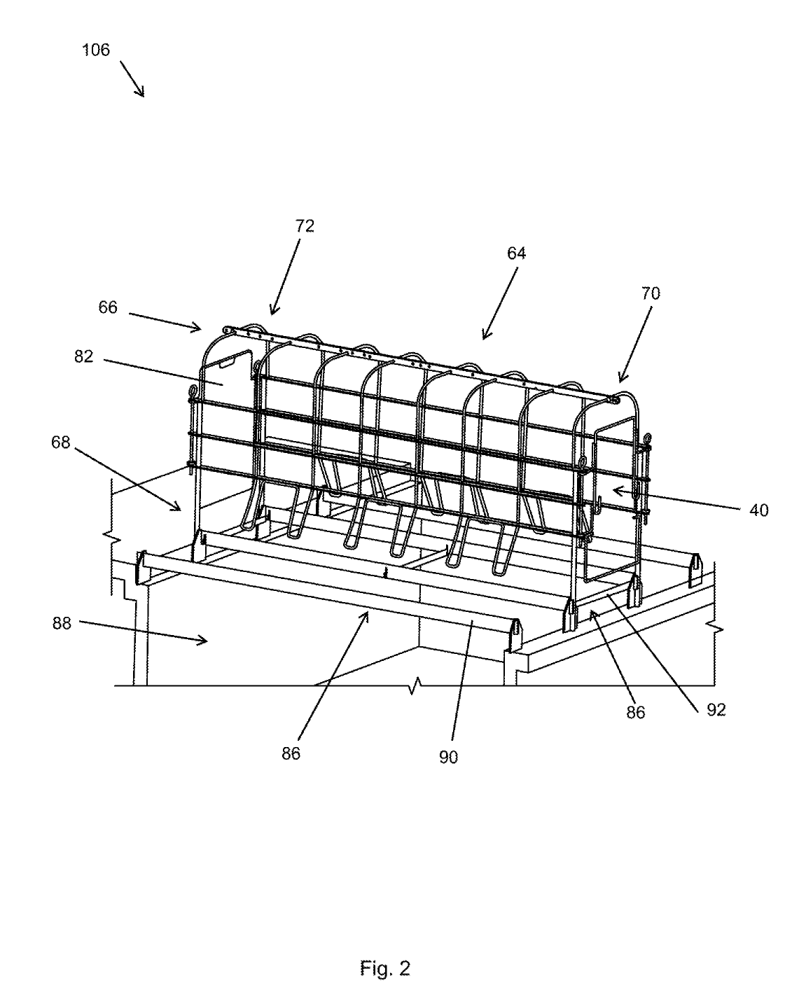

FIG. 3 is a perspective view of a partial improved biosecurity livestock system as shown in FIG. 1; the view showing a crate; the view showing a feeder system; the view showing a door assembly;

FIG. 4 is a perspective view of a feeder system as shown in FIG. 1; the view showing a door assembly; the view showing a feeder assembly;

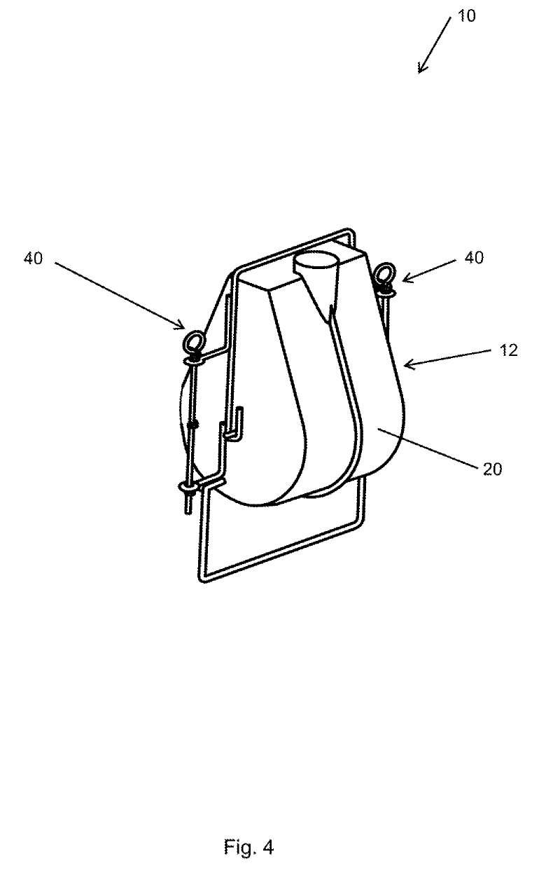

FIG. 5 is a perspective view of a feeder assembly;

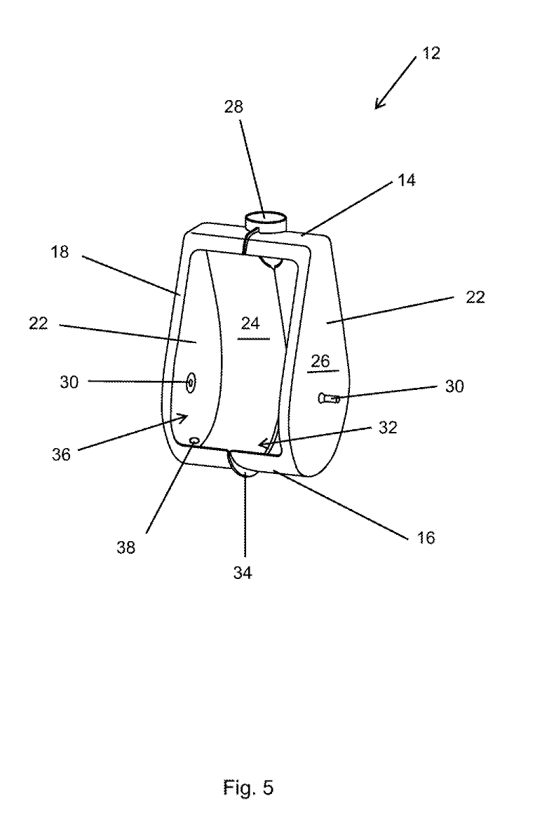

FIG. 6 is a side elevation view of a feeder assembly;

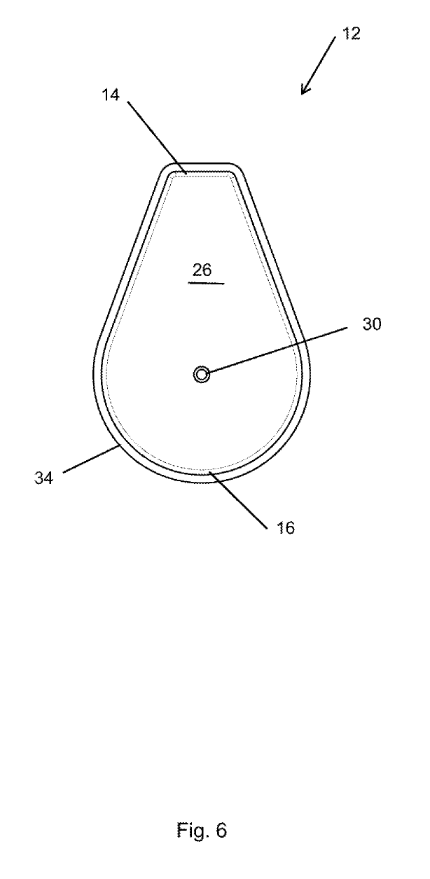

FIG. 7 is a perspective view of a door assembly;

FIG. 8 is a close up perspective view of a partial feeder system; the view showing a partial feeder assembly; the view showing a partial door assembly; the view showing a water tree;

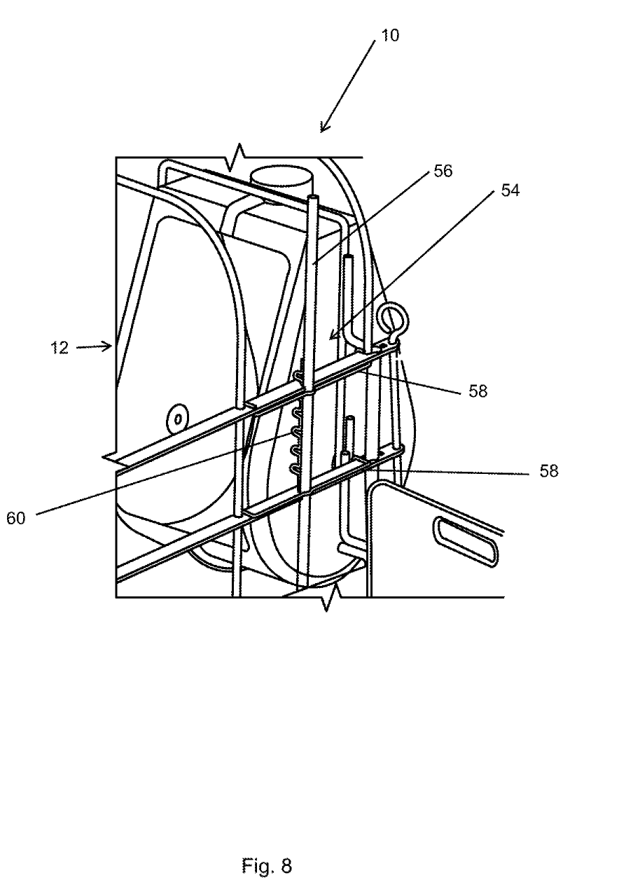

FIG. 9 is a close up perspective view of a partial feeder system; the view showing a partial feeder assembly; the view showing a partial door assembly; the view further showing a close up perspective view of a water tree;

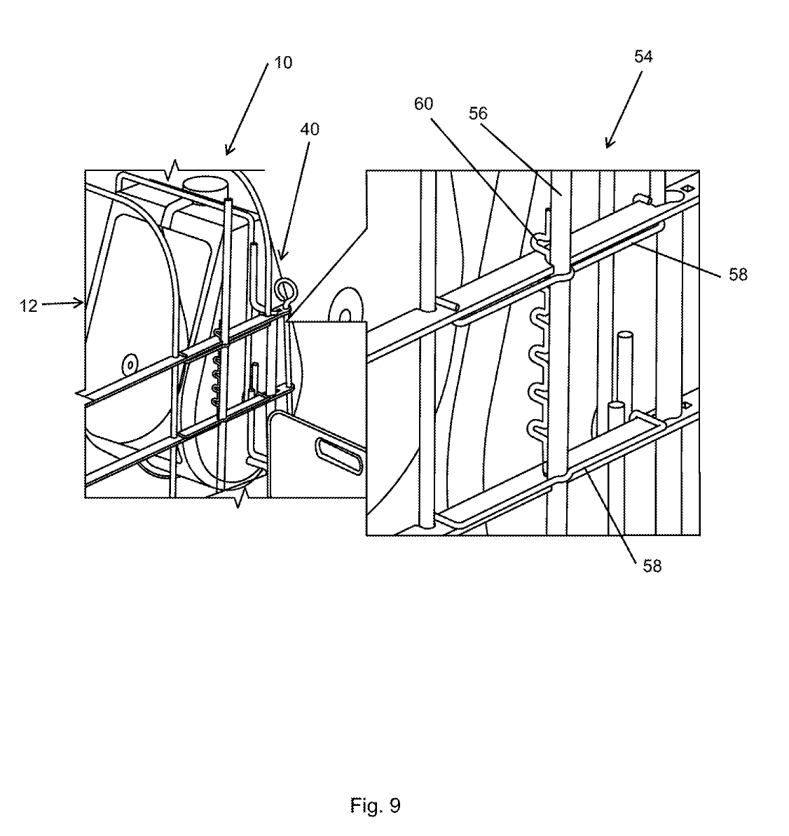

FIG. 10 is a close up perspective view of a partial feeder system; the view showing a partial feeder assembly; the view showing a partial door assembly; the view further showing a close up perspective view of a water tree; the view further showing a close up perspective view of a notch of a water tree;

FIG. 11 is a section view of the crate; the view showing a confinement area; the view showing a plurality of safety areas;

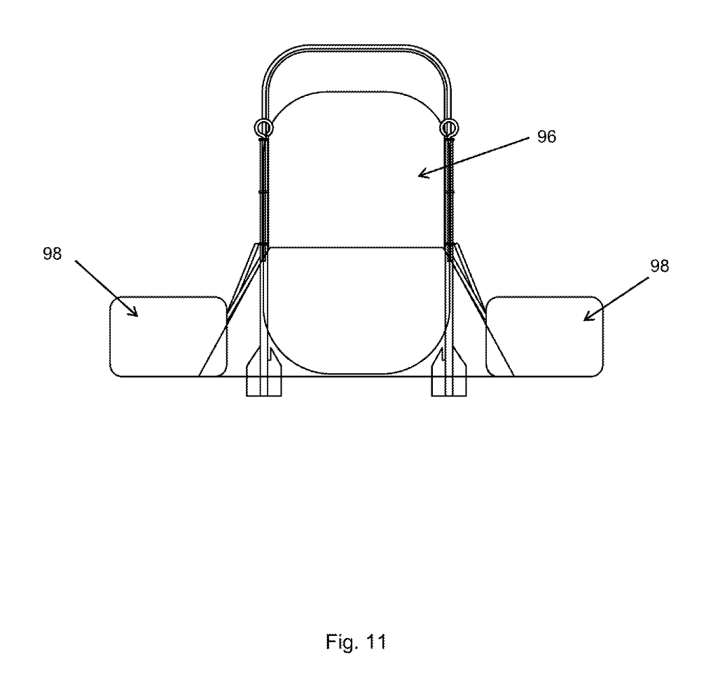

FIG. 12 is a perspective view of a partial crate; the view showing a Flying-W; the view showing a horizontal plate; the view showing a center plate; the view showing an end rod; the view showing a floor plate;

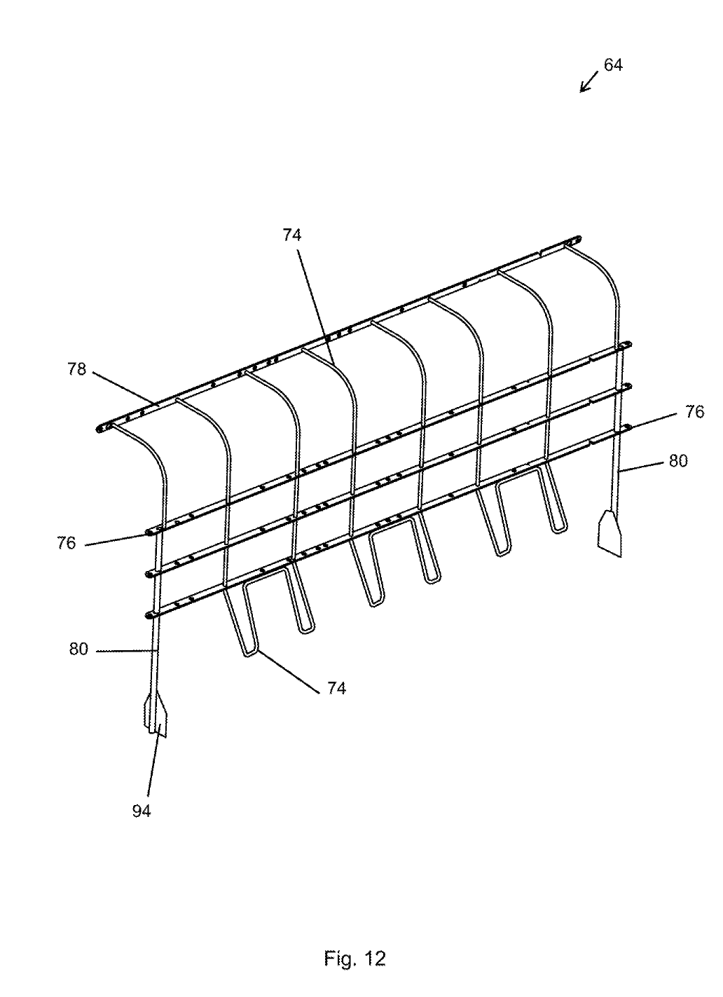

FIG. 13 is a perspective view of a partial crate; the view showing a door; the view showing a supplemental door in a closed position;

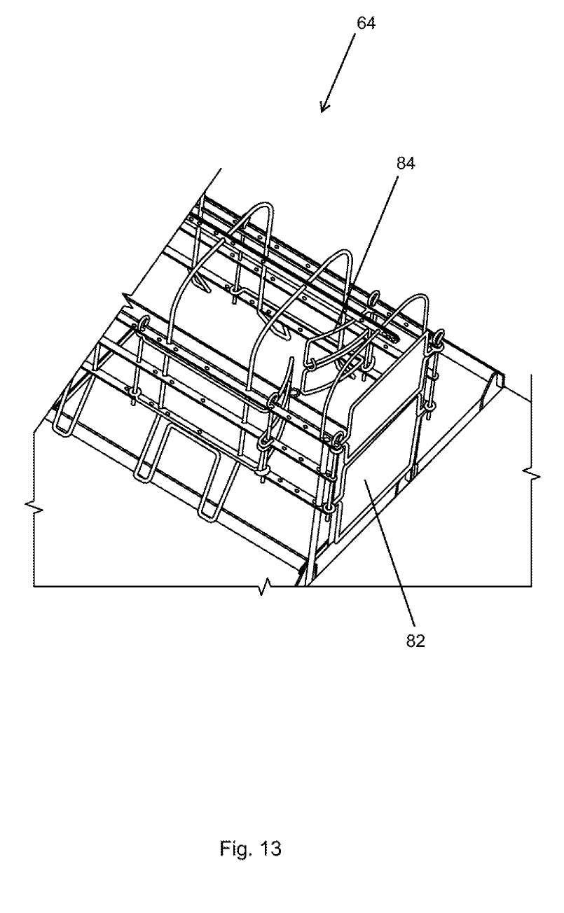

FIG. 14 is a perspective view of a partial crate; the view showing a door; the view showing a plurality of supplemental doors in an open position.

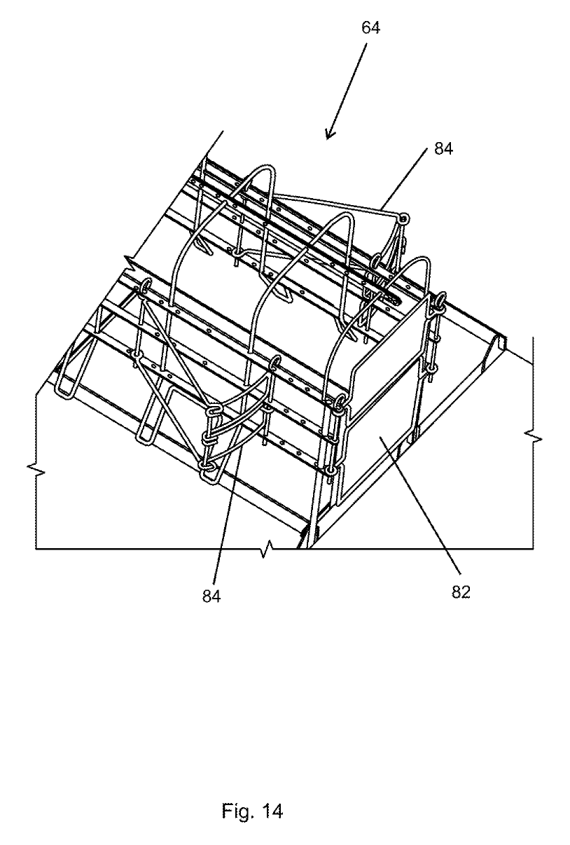

### DETAILED DESCRIPTION OF THE DISCLOSURE

In the following detailed description, reference is made to the accompanying drawings which form a part hereof, and in which is shown by way of illustration specific embodiments in which the disclosure may be practiced. These embodiments are described in sufficient detail to enable those skilled in the art to practice the disclosure, and it is to be understood that other embodiments may be utilized and that mechanical, procedural, and other changes, amendments, or revisions may be made without departing from the spirit and scope of the disclosure(s). The following detailed description is, therefore, not to be taken in a limiting sense, and the scope of the disclosure(s) is defined only by the appended claims, along with the full scope of equivalents to which such claims are entitled.

As used herein, the terminology such as vertical, horizontal, top, bottom, front, back, end, sides, left, right, and the like are referenced according to the views, pieces, parts, components and figures presented. Also, it is important to note, the term hog is utilized throughout the disclosure to refer to swine, pigs, hogs, and the like without any limitation. Furthermore, the term livestock is utilized throughout the disclosure to refer to any type of animal, livestock, and the like. It should be understood, however, that the terms are used only for purposes of description, and are not intended to be used as limitations. Accordingly, orientation of an object or a combination of objects may change without departing from the scope of the disclosure.

System:

With reference to the figures, a feeder system 10 (or simply “system 10” or “a feeder 10”) for feeding animals, livestock, and the like is presented. System 10 is used in association with many purposes including, but not limited to, providing nutrition to livestock, to limit livestock exposure to negative interactions, create biosecurity in a livestock feeding environment, increase safety of livestock and others, among many other purposes. System 10 may be utilized in association with any type of animal, livestock, and the like including, but not limited to, hogs, cattle, sheep, etc. without departing from the scope of the disclosure. System 10 may be utilized in association with any type of crate, pin, confinement apparatus, etc. without departing from the scope of the disclosure. In one arrangement, as one example, system 10 may be utilized in association with an improved biosecurity livestock system 106. In this arrangement, the improved biosecurity livestock system 106 comprises a crate 64, a bio-waste containment pit 88, a floor deck assembly 86, and a feeder system 10, among other components.

In one arrangement, as one example, system 10 is used in association with a feeder assembly 12, a door assembly 40, a water tree 54, a crate 64, a floor deck assembly 86, a confinement area 96, a safety area 98, nursery panels 100, a hardware management system 102, and an application 104, among other components. System 10 may be used in association with other features as well. System 10 may be used in association with a crate 64, a floor deck assembly 86, a confinement area 96, a safety area 98, and nursery panels 100. Nursery panel 100 and crate 64 may be configured to attach to the floor system 10. In this arrangement, as is shown in one example, nursery panel 100 and crate 64 are configured to confine livestock. System 10 may also be used in association with a hardware management system 102, an application 104, the application 104 being associated with a user (not shown in figures) and an internet enabled and/or controller enabled device such as a mobile device (not shown in figures).

The system 10 is used in association with all of these components, among other features, systems, and components as is described herein and shown in the figures.

Feeder Assembly:

In the arrangement shown, as one example, feeder system 10 is used in association with a feeder assembly 12. Feeder assembly 12 is formed of any suitable size, shape and design and is configured to function as the main housing structure to hold the feed for the livestock. In other words, feeder assembly 12 is configured to be the main point of interaction between feed and livestock. In the arrangement shown, as one example, feeder assembly 12 includes a top 14, a bottom 16, a front 18, a back 20, sidewalls 22, an interior surface 24, and an exterior surface 26. In the arrangement shown, as one example, feeder assembly 12 is used in association with a feed tube receptacle 28, pins 30, a trough 32, a flange 34, an opening 36, and at least one sensor 38.

In the arrangement shown, as one example, feeder assembly 12 is formed by two common shells mated and attached at a flange 34. In the arrangement shown, as one example, feeder assembly 12 is two stamped, deep drawn, hydroformed or other high straining forming method of mirrored geometry around a vertical plane, where the flange 34 is used to attach the two pieces together. In one arrangement, as one example, feeder assembly 12 is fabricated from a pair of stamped sections which are connected together by any means or method for attaching the components. In one arrangement, the feeder assembly 12 is fabricated by utilizing a deep-drawn process to create a common shell, similar to the process used for kitchen sink production. This process, using a common mold, die, or tooling, is used on both of the opposing sides of the feeder assembly 12, thus, reducing tooling and ultimately feeder cost. The creation of the sow access hole (inner surface access 24/32) to the feeder feed is performed either on the individual halves 22, or after the two shells are attached together 12. However, any other manufacturing method or material of a feeder assembly 12 is hereby contemplated for use including, but not limited to, injection molding, welding, gluing, friction fitting, adhering pieces, and/or other methods of assembly and materials.

Feed Tube Receptacle:

In the arrangement shown, as one example, feeder assembly 12 is used in association with a feed tube receptacle 28. Feed tube receptacle 28 is laser cut of any suitable size, shape and design and is configured to provide a port for connection with an automated feed system. In the arrangement shown, as one example, feed tube receptacle 28 may be configured to attach to a mechanized feed supply such as a pneumatic feed supply or conveyance providing feed to the feeder assembly 12 for dispensing feed into the trough 32 of the feeder assembly 12.

In the arrangement shown, as one example, feed tube receptacle 28 is generally a short tube with a cylindrical shaped opening. Furthermore, in this arrangement, the feed tube receptacle 28 is located at the top 14 of the feeder assembly 12 interlocking with the flange of both formed parts. In the arrangement shown, as one example, feed tube receptacle 28 is hollow such that a tube can be inserted, or feed can be poured into the trough 32 from any angle of the feeder assembly 12.

In the arrangement shown, as one example, feed tube receptacle 28 is created by a continuous tube laser cutting process. However, feed tube receptacle 28 may be created by any method or process without departing from the scope of the disclosure. For example, feed tube receptacle 28 may be created by forming, molding, welding, etc. Additionally, in one arrangement, feed tube receptacle 28 is formed of stainless steel, yet it is feasible due to the structure of the existing feeder that the feed tube receptacle 28 could be a snap in plastic insert. Other materials include, but are not limited to, polymers, fiberglass, steel, aluminum, enhanced polymers, polymer composites, and the like.

Pins:

In the arrangement shown, as one example, feeder assembly 12 is used in association with at least one pin 30 (hereinafter referred to as “pins,” “plurality of pins”, or “at least one pin”). Pins 30 are formed of any suitable size, shape and design and are configured to provide an attachment feature of the feeder assembly 12, such that the feeder assembly 12 can attach to a door assembly 40. Any number of pins 30 may be utilized in association with the feeder assembly 12 without departing from the scope of the disclosure. In one arrangement, as one example, the feeder assembly 12 is used in association with a pair of pins 30. However, in another arrangement, as one example, one, two, three, four, five, six, seven, eight, nine, ten, or more pins 30 may be utilized in association with the feeder assembly 12.

In the arrangement shown, as one example, pins 30 are configured such that the feeder assembly 12 can be rotated about an axis. In this way, and in the arrangement shown, as one example, pins 30 enable the feeder assembly 12 to be rotated such that the interior surface 24 is easily accessible to a handler or cleaner. In this way, the feeder assembly 12 can be easily cleaned and maintained. This improves upon the biosecurity of the feeder system 10. Additionally, in this arrangement, the feeder assembly 12 can be easily rotated and quickly put back in place with little to no effort by a handler or cleaner.

In the arrangement shown, as one example, a pin 30 is a small bar like extension, perpendicular to the sidewall 22 of the approximate center of the exterior surface 26 of the feeder assembly 12. In the arrangement shown, as one example, pins 30 engage the pin hooks 44 of the door assembly 40. Pin hooks 44 and door assembly 40 are further described herein. In this arrangement, as is shown in one example, the pins 30 are able to rotate freely in the pin hooks 44.

In the arrangement shown, as one example, pin 30 is made of formed steel. However, pins 30 may be formed of any other material without departing from the disclosure. Other materials include, but are not limited to, polymers, fiberglass, steel, aluminum, enhanced polymers, polymer composites, and the like.

Trough:

In the arrangement shown, as one example, feeder assembly 12 is used in association with a trough 32. Trough 32 is formed of any suitable size, shape and design and is configured to hold feed while the livestock consumes the feed. In the arrangement shown, as one example, trough 32 is a bowl-like, concave feature in the bottom of the interior surface 24 of the feeder assembly 12. In this way, the bottom 16 of the feeder assembly 12 is able to hold food by support structures at the front 18, the back 20, and the opposing sidewalls 22 of the bottom portion of the feeder assembly 12.

In the arrangement shown, as one example, a food level sensor 38 (or simply “sensor 38”) is used to detect when the feed level is low within the trough 32. This sensor 38, along with other sensors 38, can be used to trigger other controls of a hardware management system 102 and/or provide an alert or notification to a handler or user.

Seam or Flange:

In the arrangement shown, as one example, feeder assembly 12 is used in association with a flange 34. It should be noted that the flange 34 may also be referred to as a seam 34 without departing from the disclosure. Flange 34 may be formed of any suitable, size, shape, and design. In one arrangement, as one example, a feeder assembly 12 is fabricated from a pair of stamped sections. The feeder assembly 12 may be jointed at a common flange 34 surface in opposing directions. Additionally, in one arrangement, the feeder assembly 12 comprises an accessibility hole which may be cut prior to assembly. In one arrangement, the feeder assembly 12 may comprise an accessibility hole which is cut after the assembly of the stamped sections. In one arrangement, the feed tube receptacle 28 captures the flange 34 and assembly seam.

Sensor:

In the arrangement shown, as one example, feeder assembly 12 is used in association with at least one sensor 38. Sensor 38 may be formed of any suitable size, shape and design and is configured to detect environmental conditions of system 10. Furthermore, sensors 38 may be joined with other components which help relay that information to a controller or other device, such as a programmable logic controller. Any number of sensors 38 may be utilized by system 10 to detect any number of variables. For example, the system 10 may comprise one, two, three, four, five, six, seven, eight, nine, ten, or more sensors 38. Some sensor 38 types may include, but are not limited to, force sensors, pressure sensors, motion sensors, temperature sensors, reflex sensors, water level sensors, food level sensors, heart rate sensors, positioning sensors, weight sensors, contaminant detection and monitoring sensors, flood sensors, feeder assembly out of alignment sensors, door open sensors, and more. Furthermore, sensor 38 may be used in conjunction with a hardware management system 102.

Door Assembly:

In the arrangement shown, as one example, feeder system 10 is used in association with a door assembly 40. Door assembly 40 is formed of any suitable size, shape and design and is configured to support the feeder assembly 12 and to enable the opening and closing functions of system 10. Additionally, in the arrangement shown, as one example, door assembly 40 is configured to enable the feeder assembly 12 to rotate about a horizontal axis.

In the arrangement shown, as one example, door assembly 40 includes a frame 42, pin hooks 44, hinges 46, eyes 48, at least one drop rod 50, and an extension 52. In the arrangement shown, as one example, these components as well as others may form a door assembly 40. However, not all of these components are required for a door assembly 40.

Frame:

In the arrangement shown, as one example, door assembly 40 includes a frame 42. Frame 42 is formed of any suitable size, shape and design and is configured to house the feeder assembly 12. Additionally, in the arrangement shown, as one example, frame 42 is configured to be the main body of the door assembly 40, supporting the other features of the door assembly 40. In the arrangement shown, as one example, the other components of the door assembly are welded to the frame 42, with the exception being the drop rods 50. Drop rods 50 are further described herein. In the arrangement shown, as one example, frame 42 is a generally rectangular formed metal bar. At each end of the form is a pin hook 44.

Pin Hooks:

In the arrangement shown, as one example, door assembly 40 is used in association with at least one pin hook 44 (hereinafter referred to as “pin hooks”, “pin hook”, “a plurality of pin hooks”, or “at least one pin hook”). Pin hooks 44 are formed of any suitable size, shape and design and are configured to support the feeder assembly 12. Additionally, in the arrangement shown, pin hooks 44 are configured to provide a location for the pins 30 to be inserted. Any number of pin hooks 44 may be utilized in association with the door assembly 40. In one arrangement, as one example, a pair of pin hooks 44 is used in association with the door assembly 40 and a plurality of pins 30. However, in another arrangement, as one example, one, two, three, four, five, six, seven, eight, nine, ten, or more pin hooks 44 may be utilized without departing from the scope of the disclosure.

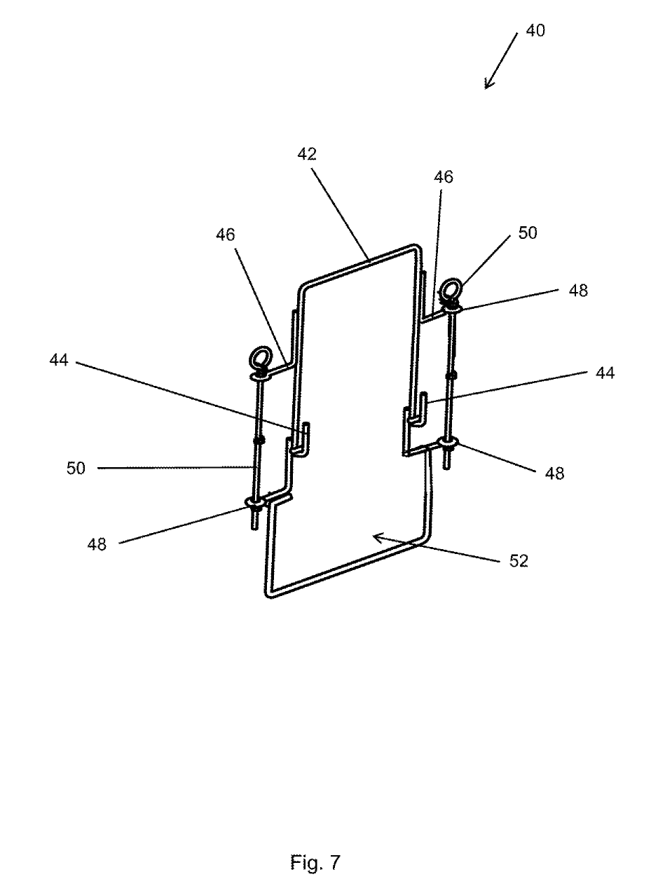

In the arrangement shown, as one example, pin hooks 44 are a continuation of the bar which forms the frame 42. In this way, and in the example shown, pin hooks 44 are formed as two bends applied to the end of the bar which forms the frame 42. In this way, and with reference to FIG. 7, the pin hooks 44 form a “U” shape, which a pin 30 of the feeder assembly 12 can be dropped into. In the arrangement shown, as one example, pin hooks 44 are designed to provide enough frictional force that the feeder assembly 12 can be rotated for cleaning and the like. Additionally, in this way pin hooks 44 are designed with a coefficient of friction great enough to keep the feeder assembly 12 in a still location while livestock are feeding.

In the arrangement shown, as one example, pin hooks 44 are an extension of the bar which forms the frame 42. However, pin hooks 44 may be comprised of any form, including, but not limited to, bearings or separate features which are capable of receiving the feeder assembly 12. In this same way, in the arrangement shown, as one example, two pin hooks 44 are used.

In the arrangement shown as one example, pin hooks 44 are formed of bended wire. However, any other material which is adequate for forming the pin hooks 44 is hereby contemplated for use without departing from the scope of the disclosure. Other materials include, but are not limited to, hollow tube, polymers, enhanced polymers, other metal materials, composites, and/or any combination thereof.

Supplemental Door:

Supplemental door 84 may be formed of any suitable size, shape, and design and is configured to force a sow or other livestock forward and provide a secure passage area for piglets to travel between safety areas 98 behind the confinement area 96. Sows and other livestock come in varying shapes and sizes. Some sows are longer than others from nose to rear. In the arrangement shown, as one example, the supplemental door 84 is adjustable and able to be relocated along the length of the horizontal plates 76. Thus, in the arrangement shown, as one example, supplemental door 84 is configured to provide an enclosure at varying points along the length of improved biosecurity livestock system 106 so as to force varying sizes of livestock forward in the confinement area 96.

In one arrangement, as one example, supplemental door 84 includes at least one upper horizontal bar, at least one lower horizontal bar, at least one pivot bar, at least one drop rod, and at least one set of eyes. In one arrangement, as shown, the supplemental doors 84 are not only configured to position a livestock to the front of the confinement area 96, but the supplemental doors 84 are also configured to pivot fully into and out of the confinement area 96 to allow loading sow into crate. Horizontal doors eliminate the need for operators to lift doors.

In one arrangement, as one example, the supplemental doors 84 are made from steel or stainless steel rods. However, any other material which is adequate for forming the supplemental doors 84 is hereby contemplated for use without departing from the disclosure. Other materials include, but are not limited to, rebar, hollow tube, polymers, enhanced polymers, other metal materials, composites, or any combination thereof.

Hinges:

In the arrangement shown, as one example, door assembly 40 is used in association with at least one hinge 46 (hereinafter “hinge”, “hinges”, “a plurality of hinges”, or “at least one hinge”). Hinges 46 are formed of any suitable size, shape and design and are configured to support the door assembly 40. Additionally, in the arrangement shown, as one example, hinges 46 are configured to provide support arms for the rotation of the door assembly 40.

In the arrangement shown, as one example, hinges 46 are formed of a bent metal bar welded to the frame 42. However, any other material which is adequate for forming the hinges 46 is hereby contemplated for use without departing from the scope of the disclosure. Other materials include, but are not limited to, hollow tube, polymers, enhanced polymers, other metal materials, composites, and/or any combination thereof.

In the arrangement shown, as one example, each side of the frame 42 has two hinges 46 extending therefrom in an approximate perpendicular orientation. However, any other number of hinges 46 is hereby contemplated for use. For example, one, two, three, four, five, six, seven, eight, nine, ten, or more hinges 46 are contemplated for use without departing from the disclosure. In the arrangement shown, as one example, hinges 46 are in vertical alignment with one another, such that the eye 48 attached at each hinge 46 is in alignment with the other eye 48. This arrangement allows for a drop rod 50 to slide through the two eyes 48.

Eyes:

In the arrangement shown, as one example, door assembly 40 is used in association with at least one eye 48. Eye 48 is formed of any suitable size, shape and design and is configured to receive a drop rod 50 therein. Additionally, in the arrangement shown, as one example, eye 48 is configured to serve as a collar and/or connection point supporting attachment of the hinge 46 and the rest of the door frame 42.

In the arrangement shown, as one example, eye 48 is formed of a circle of metal such that a drop rod 50 can slide into and through the center of the eye 48. In the arrangement shown, as one example, each eye 48 is attached by welding to the end of the hinge 46. In another arrangement, each eye 48 may be formed as an extension of the bar which forms the hinge 46. In this arrangement, bending can be used to mold a circular like shape at the end of the hinge 46, such that an eye 48 is formed.

In the arrangement shown, as one example, eye 48 is formed of a bent metal rod. However, any other material which is adequate for forming the hinges 46 is hereby contemplated for use without departing from the scope of the disclosure. Other materials include, but are not limited to, hollow tube, polymers, enhanced polymers, other metal materials, composites, and/or any combination thereof.

In the arrangement shown, as one example, four eyes 48 are shown. With reference to FIG. 7, each side of the frame 42 has a set of two eyes 48 such that the door assembly 40 can be attached to another structure. However, any other number of eyes 48 is hereby contemplated for use.

Drop Rod(s):

In the arrangement shown, as one example, door assembly 40 is used in association with a drop rod 50. Drop rod 50 is formed of any suitable size shape and design and is configured to attach the door assembly 40 to the crate 64, or other structure. In the arrangement shown, as one example, drop rod 50 is formed of a slender metal rod with a loop on one end. In this way, as is shown in FIG. 7, drop rod 50 can be slid into the eyes 48 of the door frame 42, but the loop of the drop rod 50 will catch at the top eye 48. In this way, the drop rod 50 is prevented from sliding/slipping through the entire door assembly 40.

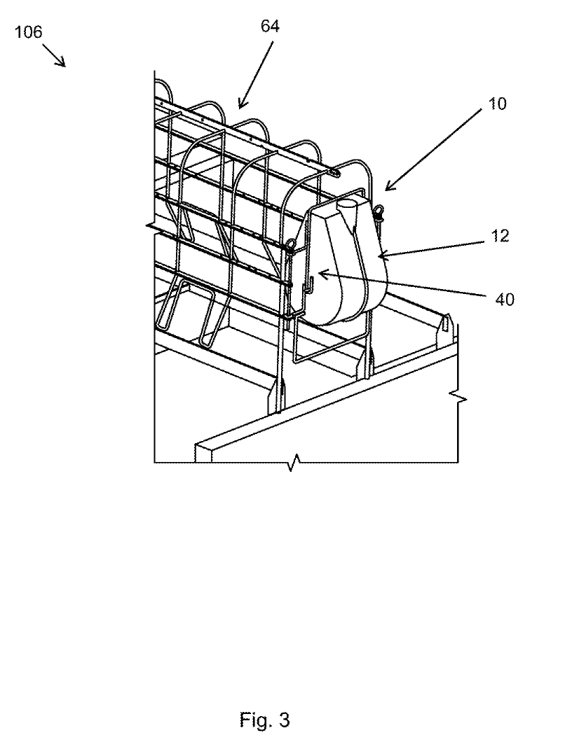

In the arrangement shown, as one example, and with reference to FIG. 3, drop rod 50 is inserted through the eyes 48 as well as through positioning holes of the horizontal plate 76 of the crate 64. In this way, drop rod 50 creates a hinged connection between the crate 64 and the door assembly 40.

In the arrangement shown, as one example, drop rod 50 is formed of a metal bar with a loop bent at one end. However, any other end and/or form which prevents drop rod 50 from slipping through, and/or other connection means, are hereby contemplated for use. In addition, in the arrangement shown, two drop rods 50 are used. One drop rod 50 located on each side of the door assembly 40. However, any other number of drop rods 50 is hereby contemplated for use. The system 10 may comprise one, two, three, four, five, six, seven, eight, nine, ten, or more drop rods 50 without departing from the scope of the disclosure.

In the arrangement shown, as one example, drop rod 50 is formed of a steel or other type of metal. However, any other material which is adequate for forming the drop rod 50 is hereby contemplated for use without departing from the scope of the disclosure. Other materials include, but are not limited to, hollow tube, polymers, enhanced polymers, other metal materials, composites, and/or any combination thereof

Extension:

In the arrangement shown, as one example, door assembly 40 is used in association with an extension 52. Extension 52 is formed of any suitable size, shape and design and is configured to provide an extension outside the feeder assembly 12 which can prevent a sow from escaping containment within the crate 64. In other words, extension 52 is an extension of the frame 42 that creates a barrier for the sow or other livestock.

Extension 52 may extend in any direction from the feeder assembly 12. In the arrangement shown, as one example, extension 52 is formed of a bent metal bar extending downward from the frame 52. In the arrangement shown, as one example, extension 52 is welded to the bottom part of frame 52. However, any other material for forming extension 52 is hereby contemplated for use. Other materials include, but are not limited to, hollow tube, polymers, enhanced polymers, other metal materials, composites, and/or any combination thereof.

In the arrangement shown, as one example, extension 52 is a bar which creates a barrier. However, extension 52 may be formed as a panel or any other obstruction which aids in creating a barrier. In the arrangement shown, as one example, only one extension 52 is needed to create a barrier for create 64. However, any other number of extensions 52 is hereby contemplated for use without departing from the disclosure.

Water Tree:

In the arrangement shown, as one example, system 10 may include a water tree 54. Water tree 54 may be formed of any suitable size, shape and design and is configured to provide water and/or other nutrients to the livestock housed within the confinement area 96 or the safety area 98. In the arrangement shown, as one example, water tree 54 includes a pipe 56, a retention wire 58, a position form wire 60, and a notch 62.

Pipe:

In the arrangement shown, as one example, water tree 54 includes a pipe 56. Pipe 56 is formed of any suitable size, shape and design and is configured to provide a conveyance means to the livestock housed within the confinement area 96 and/or the safety area 98. In the arrangement shown, as one example, pipe 56 is formed of a common copper pipe or PVC tubing capable of carrying fluid. However, any other material for carrying fluid such as a plastic pipe, metal tubing, or the like is hereby contemplated for use.

Retention Wire:

In the arrangement shown, as one example, pipe 56 is secured to the horizontal plates 76 of the crate 64 by at least one retention wire 58. Retention wire 58 is formed of any suitable size, shape and design and is configured to attach and hold the pipe 56 in position. In the arrangement shown, as one example, retention wire 58 is formed of spring wire and is formed to the positioning holes of the horizontal plate 76. In the arrangement shown, as one example, the ends of the retention wire 58 clip over the horizontal plate 76. In this arrangement, as is shown, no tools are needed to use retention wire(s) 58 to secure the pipe 56 to the horizontal plates 76.

Any number of retention wires 58 may be utilized in association with the water tree 54 without departing from the scope of the disclosure. In one arrangement, as one example, the water tree 54 comprises one retention wire 58. However, in another arrangement, the water tree 54 may comprise two, three, four, five, six, seven, eight, nine, ten, or more retention wires 58 without departing from the disclosure.

Position Form Wire:

In the arrangement shown, as one example, water tree 54 is used in association with at least one position form wire 60. Position form wire 60 is formed of any suitable size, shape and design and is configured to keep the pipe 56 from moving vertically along the horizontal plate(s) 76. In the arrangement shown, as one example, position form wire(s) 60 are cnc formed wires molded into a repeating “S” shape such that the wire can inter-connect with the horizontal plates 76. In the arrangement shown, as one example, the position retention wire 60 is welded to the pipe 56. However, any other method of connecting the position retention wire 60 to the pipe 56 may be utilized without departing from the disclosure. Also, any number of position form wires 60 may be utilized. In one arrangement, as one example, one position form wire 60 is utilized in association with the water tree 54. While in another arrangement, as an example, two, three, four, five, six, seven, eight, nine, ten, or more position form wires 60 may be utilized without departing from the disclosure.

Notch:

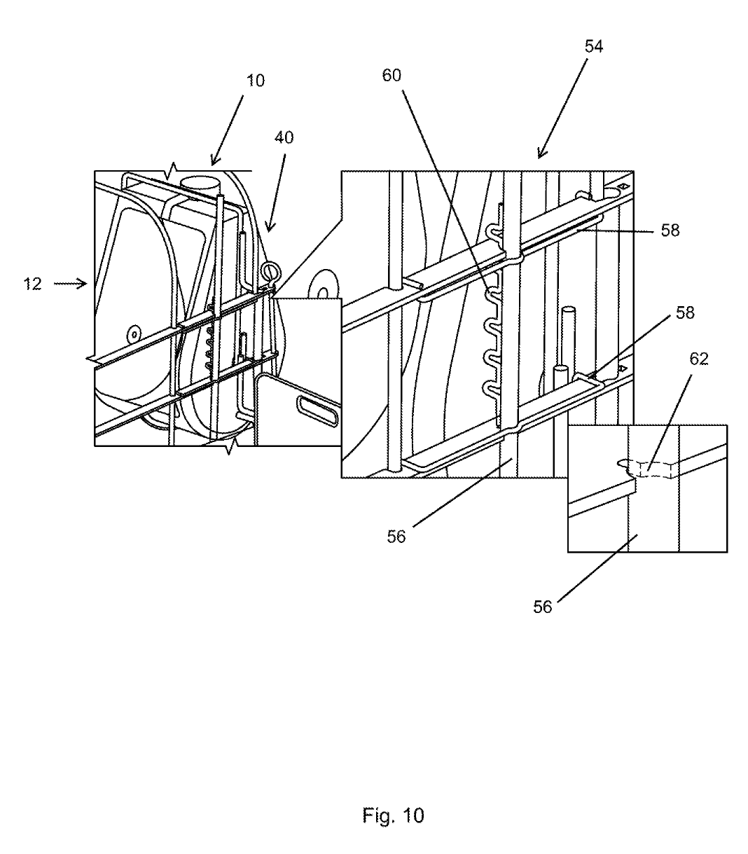

In the arrangement shown, as one example, water tree 54 is used in association with at least one notch 62. Notch 62 is formed of any suitable size, shape and design and is configured to provide an inset in the horizontal plate 76 for which the pipe 56 rests. In the arrangement shown, as one example, and with reference to FIG. 10, notch 62 is a semi-circular recess in the side of the horizontal plate 76. In the arrangement shown, as one example, notch 62 is sized in accordance with the circumference of pipe 56 such that pipe 56 fits in notch 62 with close and tight tolerances. In this way, notch 62 further houses and stabilizes the water tree 54.

Crate:

In the arrangement shown, as one example, feeder system 10 is used in association with a crate 64. Crate 64 may be formed of any suitable size, shape and design and is configured to provide a 3-dimensional, structural confinement area for the livestock. In the arrangement shown, as one example, crate 64 is configured to provide a physical barrier between the safety area 98 and the confinement area 96. In the arrangement shown, as one example, crate 64 has a top 66, a bottom 68, a front 70, and a back 72.

In the arrangement shown, as one example, crate 64 is formed of at least one Flying-W 74, at least one horizontal plate 76, at least one center plate 78, and at least one end rod 80. Additionally, crate 64 may include at least one door 82. In the arrangement shown, as one example, door 82 is located on, and hingedly connected to the back 72 of crate 64. Door 82 is further described herein.

Flying-W:

In the arrangement shown, as one example, crate 64 is used in association with at least one Flying-W 74. The at least one Flying-W 74 may be formed of any suitable size, shape and design and is configured to provide the 3-dimensional, structural design of the main body of the crate 64. In other words, the Flying-W 74 is configured to provide the crate 64 with its shape. The Flying-W 74 is also configured to provide the crate 64 with its strength.

In the arrangement shown, as one example, the Flying-W 74 is formed in a shape that looks like a “W”, i.e., the origin of the Flying-W name. In this arrangement, the “W” forms the lower portion of the Flying-W 74. In the arrangement shown, as one example, the at least one Flying-W 74 is formed of a continuous bar. In this way, in the arrangement shown, as one example, the Flying-W 74 gives the confinement area 96 its shape.

In the arrangement shown, as one example, the Flying-W 74 is comprised of a size that allows for the crate 64 to be utilized as a farrowing crate which can comfortably house a single sow. However, any other size of the Flying-W 74 is hereby contemplated for use without departing from the disclosure. Additionally, the thickness of the continuous wire, which forms the Flying-W 74, is comprised of a size that provides strength in order to contain a sow in a safe manner. However, any other size of continuous wire is hereby contemplated for use without departing from the disclosure.

In the arrangement shown, as one example, three Flying-W 74 configurations are used to provide a stable crate 64. However, any number of Flying-W 74 configurations may be used to configure an appropriately sized crate 64 without departing from the disclosure. For example, the crate 64 may comprise one, two, three, four, five, six, seven, eight, nine, ten, or more Flying-W 74 configurations without departing from the disclosure.

In the arrangement shown, as one example, the Flying-W 74 is located or positioned in order to form the main body of the crate 64. In the arrangement shown, as one example, three Flying-W 74 configurations are positioned an equal distance from one another along the length of the center plate 78 and the horizontal plates 76. In the arrangement shown, as one example, the Flying-W 74 is positioned such that it is operably connected to the at least one horizontal plate 76.

Horizontal Plate:

In the arrangement shown, as one example, the crate 64 is used in association with at least one horizontal plate 76. The at least one horizontal plate 76 may be formed of any suitable size, shape and design and is configured to provide horizontal support to the Flying-W 74. In other words, as is shown in the example, horizontal plate 76 is configured to increase the structural strength of the crate 64. The structural strength of the crate 64 may be increased, if necessary, by increasing the number of horizontal plates 76 used in the crate 64.

In the arrangement, as shown, the at least one horizontal plate 76 is designed to prevent, or limit, horizontal movement of the at least one Flying-W 74. In this way, the at least one horizontal plate 76 prevents the at least one Flying-W 74 from moving horizontally by enclosing the Flying-W 74 in one or more of a plurality of positioning holes. Additionally, in the arrangement shown, as one example, the at least one horizontal plate 76 is stabilized at each end by an end rod 80 which transfers any horizontal forces applied to the horizontal plate 76 to the ground. End rod 80 is further described herein.

In the arrangement shown, as one example, the at least one horizontal plate 76 is attached to other features of the crate 64 by welding. However, any other type, method, or form of attachment means is hereby contemplated for use including, but not limited to, friction fit, bolting, threading, gluing, and the like. Furthermore, in the arrangement shown, as one example, six horizontal plates 76 are used in the design of the crate 64. However, any number of horizontal plates 76 is hereby contemplated for use including one, two, three, four, five, six, seven, eight, nine, ten, or more horizontal plates 76.

In the arrangement shown, as one example, the at least one horizontal plate 76 is made from flattened or plated steel. However, any other material which is adequate for forming the at least one horizontal plate 76 is hereby contemplated for use without departing from the scope of the disclosure. Other materials include, but are not limited to, hollow tube, polymers, enhanced polymers, other metal materials, composites, and/or any combination thereof

Center Plate:

In the arrangement shown, as one example, crate 64 is used in association with at least one center plate 78 (hereinafter referred to as “a center plate”, “center plates”, “a plurality of center plates”, or “at least one center plate” without departing from the disclosure). Center plate 78 may be formed of any suitable size, shape and design and is configured to connect the opposing sides of the crate 64. In other words, the at least one center plate 78 is configured like a spine, connected to each of the Flying-W 74 configurations. The structural strength of the crate 64 can be increased, if necessary, by adding a plurality of center plates 78.

In the arrangement shown, as one example, the at least one center plate 78 is similar in size, shape and design to the at least one horizontal plate 76. In the arrangement shown, as one example, the at least one center plate 78 is slender or thin. In the arrangement shown, as one example, the at least one center plate 78 is comprised of a size to provide an adequate space for a sow from at least the nose of the sow to the tail of the sow. However, any other size and length of center plate 78 is hereby contemplated for use without departing from the disclosure. For example, a center plate 78 which is formed of a length long enough to house one, two, three, four, five, six, seven, eight, nine, ten, or more sows or any other livestock is hereby contemplated for use.

In the arrangement shown, as one example, the at least one center plate 78 is made from flattened or plated steel. However, any other material which is adequate for forming the at least one center plate 78 is hereby contemplated for use. Other materials include, but are not limited to, hollow tube, polymers, enhanced polymers, other metal materials, composites, or any combination thereof.

In an alternative embodiment, the at least one center plate 78 may be configured to connect and support multiple crates 64 arranged side by side, in either or both of a length and/or width arrangement. Additionally, at least one center plate 78 may be used as providing a connection and webbing for a plurality of crates 64.

End Rod:

In the arrangement shown, as one example, feeder system 10 is used in association with at least one end rod 80 (hereinafter referred to as “end rod”, “end rods”, “a plurality of end rods”, or “at least one end rod” without departing from the disclosure). At least one end rod 80 may be formed of any suitable size, shape and design and is configured to support the horizontal plate(s) 76 which support the door assembly 40. Thus, the at least one end rod 80 supports the feeder system 10. Additionally, in the arrangement shown, as one example, the at least one end rod 80 is configured to attach the main body of the confinement crate 64. In the arrangement shown, as one example, end rod 80 is configured to attach to the end of the horizontal plate 76 to provide support and stabilize the horizontal plate 76. Additionally, end rod 80 is configured to transfer any forces on the above main body of the confinement crate 64 and the feeder system 10.

In the arrangement shown, as one example, end rod 80 is a continuous rod or wire which extends a length from a first end to a second end. In the arrangement shown, as one example, end rod 80 is a circular rod or circular tube which is shaped in a straight fashion extending from the floor plate 94 to the crate 64. However, end rod 80 may be formed of any size or shape without departing from the disclosure.

In the arrangement shown, as one example, end rod 80 is stainless steel or steel to provide a robust resistance to the acidity of animal contaminants. However, end rod 80 may be formed of any other material adequate to support the other components of system 10. Any other material used for end rod 80 is hereby contemplated for use. Other materials include, but are not limited to, rebar, hollow tube, polymers, enhanced polymers, other metal materials, composites, or any combination thereof.

Door(s):

In the arrangement shown, as one example, crate 64 is used in association with at least one door 82 (hereinafter referred to as “door”, “doors”, “a plurality of doors”, or “at least one door”). Door 82 may be formed of any suitable size, shape and design and is configured to provide an entrance for livestock to enter the confinement area 96 and feed from system 10. In the arrangement shown, as one example, more than one door 82 may be used for this purpose. However, any number of doors 82 may utilized without departing from the scope. For example, one arrangement may comprise one, two, three, four, five, six, seven, eight, nine, ten, or more doors 82.

In the arrangement shown, as one example, door 82 is generally flat and rectangular and is configured to provide an enclosure to prevent livestock from escaping the confinement area 96 and/or to prevent unwanted livestock from entering the confinement area 96. In the arrangement shown, as one example, door 82 is hingedly connected to crate 64. However, other arrangements of a door 82 and/or other connections for door 82 to crate 64 are hereby contemplated for use.

In the arrangement shown, as one example, the door 82 is made from steel panels and/or stainless steel rods and wire. However, any other material which is adequate for forming the door 82 is hereby contemplated for use without departing from the disclosure. Other materials include, but are not limited to, rebar, hollow tube, polymers, enhanced polymers, other metal materials, composites, or any combination thereof.

Floor Deck Assembly:

In the arrangement shown, as one example, feeder system 10 is used in association with a crate 64 located or positioned over a floor deck assembly 86 which is configured to assist in creating a bio-secure environment. Floor deck assembly 86 is formed of any suitable size, shape and design and is configured to support livestock while livestock eat. In the arrangement shown, as one example, floor deck assembly 86 includes a contaminant pit 88, a beam 90, a stiffener 92, and a floorplate 94.

Bio-Waste Contaminant Pit:

In the arrangement shown, as one example, floor deck assembly 86 is used in association with a bio-waste contaminant pit 88. Bio-waste contaminant pit 88 is formed of any suitable size, shape, and design and is configured to collect and hold bio-waste and discarded food. Furthermore, bio-waste containment pit 88 provides an easy clean-out of waste.

Beams:

In the arrangement shown, as one example, the structure of the floor deck assembly 86 is used in association with at least one beam 90. Beam 90 is formed of any suitable size, shape, and design and is configured to provide support for livestock by supporting panels or other structures located on top of the beams 90. In the arrangement shown, as one example, beams 90 are a generally flat, rectangular bar turned on its slender side to maximize strength. Additionally, beams 90 are arranged along their slender side to maximize the opening space for which contaminants can fall to the contaminant pit 88 below. This minimizes how many contaminants are caught on beams 90 to almost nothing, while maximizing bio-security of system 10.

In the arrangement shown, as one example, beams 90 are made of stainless steel. Stainless steel is a material that can handle long-term exposure to animal contaminants and food waste. Thus, the stainless steel is able to prevent structural failure. However, beams 90 may be formed of any other material without departing from the scope of the disclosure. Other materials include, but are not limited to, polymers, fiberglass, steel, aluminum, enhanced polymers, polymer composites, and the like.

Stiffeners:

In the arrangement shown, as one example, floor deck assembly 86 is used in association with at least one stiffener 92 (hereinafter referred to as “a stiffener”, “stiffeners”, “a plurality of stiffeners”, or “at least one stiffener”). Stiffeners 92 are formed of any suitable size, shape and design and are configured to stiffen the beams 90, adding strength to the floor deck assembly 86. Any number of stiffeners 92 may be utilized in association with the floor deck assembly 86. In one arrangement, as one example, the floor deck assembly 86 may comprise six stiffeners 92. However, in another arrangement, as one example, one, two, three, four, five, six, seven, eight, nine, ten, or more stiffeners 92 may be utilized in association with the floor deck assembly 86 without departing from the scope of the disclosure.

In the arrangement shown, stiffeners 92 are formed of a generally flat, rectangular stainless steel bar. In the arrangement shown, as one example, the stiffeners 92 include a notch at each end. The notches of the stiffeners 92 enable the stiffeners 92 to be attached to the beams 90 by interlocking. In this way, installation is more quick and efficient. Likewise, disassembly is more quick and efficient. In this way, the floor deck assembly 86 can be assembled and disassembled with few or no tools.

In the arrangement shown, as one example, stiffeners 92 are made of stainless steel. However, stiffeners 92 could be formed of any other material without departing from the disclosure. Other materials include, but are not limited to, polymers, fiberglass, steel, aluminum, enhanced polymers, polymer composites, and the like.

Floor Plate:

In the arrangement shown, as one example, floor deck assembly 86 is used in association with at least one floor plate 94 (hereinafter referred to as “floor plate”, “floor plates”, “a plurality of floor plates”, or “at least one floor plate”). At least one floor plate 94 may be formed of any suitable size, shape and design and is configured to provide support for crate 64. Furthermore, the at least one floor plate 94 provides a means for connecting the crate 64 to the floor deck assembly 86. In the arrangement shown, as one example, floor plate 94 is a generally flat piece of steel configured to attach the crate 64 to the floor deck assembly 86. Any number of floor plates 94 may be utilized in association with the floor deck assembly 86. In one arrangement, as one example, four floor plates 94 are used in association with the floor deck assembly 86. However, one, two, three, four, five, six, seven, eight, nine, ten, or more floor plates 94 may be utilized without departing from the disclosure.

In the arrangement shown, as one example, the at least one floor plate 94 is made from flattened or plated steel. However, any other material which is adequate for forming the at least one floor plate 94 is hereby contemplated for use. Other materials include, but are not limited to, hollow tube, polymers, enhanced polymers, other metal materials, composites, or any combination thereof

Confinement Area:

In the arrangement shown, as one example, feeder system 10 is used in association with a confinement area 96. Confinement area 96 may be formed of any suitable size, shape and design and is configured to house livestock. In the arrangement shown, as one example, confinement area 96 is formed by the crate 64 and partially by the door assembly 40.

In the arrangement shown, as one example, the confinement area 96 includes a rearward end where a sow or other livestock enters the confinement area 96. Additionally, in the arrangement shown, as one example, the confinement area 96 includes a forward end where the feeder system 10 is located. Livestock face the forward end after entering the confinement area 96. In the arrangement shown, as one example, livestock may feed while standing in the confinement area 96 and placing their head through the opening 36 of the feeder assembly 12.

In the arrangement shown, as one example, confinement area 96 is generally a rectangular space, similar to a small corridor, with an arced top surface formed by the upper portions of the crate 64, which extend above the confinement area 96. In the arrangement shown, as one example, confinement area 96 is shaped to house a sow in a manner which a full grown sow cannot turn around in the confinement area 96. In the arrangement shown, as one example, confinement area 96 is shaped and sized in order for a sow to stand up and lie down. Additionally, confinement area 96 is shaped and sized in order for a sow to nurse piglets confined in an adjoining safety area 98. However, any other size or shape is hereby contemplated for use, including shapes and sizes for various livestock, and for various quantities of livestock.

Safety Area:

In the arrangement shown, as one example, feeder system 10 may be used in association with a safety area 98. Safety area 98 may be formed of any suitable size, shape and design and is configured to provide an area of refuge for piglets to escape the presence of the sow. In the arrangement shown, as one example, two safety areas 98, also referred to as piglet areas, are located adjacent to the confinement area 96. In the arrangement shown, as one example, a safety area 98 is an area that the adult livestock within the confinement area 96 cannot move to. In the arrangement shown, as one example, only a piglet or a much smaller livestock can pass through the lower portion of the crate 64. Thus, in this arrangement, a safety area 98 for the piglets is created.

In the arrangement shown, as one example, safety area 98 is formed by a safety area floor which includes at least one safety area floor panel. In the arrangement shown, as one example, the safety area 98 is a rectangular, flat shape which is adjacent to, and approximately level with, the confinement area 96. In the arrangement shown, as one example, the safety area 98 is large enough to house an entire litter of piglets such that the piglets can escape the confinement area 96. In the arrangement shown, as one example, the safety area 98 is designed as a bio-secure area where piglets can safely nurse.

In the arrangement shown, as one example, the safety area 98 is formed of a safety area floor which comprises safety area floor panels with holes. In this arrangement, the holes allow contaminants to pass through the safety area floor panels and into a contaminant pit 88. In the arrangement shown, as one example, the safety area 98 is configured above a contaminant pit 88 such that gravitational force can pull contaminants, including escaped feed, from the safety area 98 and into the contaminant pit 88. In this way, piglets will not intake or choke on any stray feed that has accidentally entered the safety area 98.

In the arrangement shown, as one example, the safety area 98 is surrounded along three sides by nursery panels 100. Nursery panels 100 may also be referred to as guards 100 without departing from the scope of the disclosure. Nursery panels 100 are further described herein. In the arrangement shown, as one example, the nursery panels 100 form three sides of the safety area 98 while the fourth side abuts the confinement area 96.

In the arrangement shown, as one example, floor deck assembly 86 includes two types of bio-secure floor panels. In the arrangement shown, as one example, the confinement area floor, which houses the sow or livestock, uses a confinement area panel which is designed to overlap and interlock with the safety area 98 safety area floor panels.

Nursery Panels:

In the arrangement shown, as one example, feeder system 10 may be used in association with at least one nursery panel 100 (hereinafter referred to as “nursery panel”, “nursery panels”, “a plurality of nursery panels”, or “at least one nursery panel” without departing from the disclosure). Nursery panel 100 may be formed of any suitable size, shape and design and is configured to form an enclosure around the safety area 98 such that livestock and/or piglets are contained within the safety area 98. Any number of nursery panels 100 may be utilized by the feeder system 10. In one arrangement, as one example, the feeder system 10 comprises three nursery panels 100. However, one, two, three, four, five, six, seven, eight, nine, ten, or more nursery panels 100 may be utilized by the feeder system 10 without departing from the disclosure.

Installation & Operation:

In the arrangement shown, as one example, feeder system 10 is easy to install and provides novel installation features which solve long-standing needs in the art. In the arrangement shown, as one example, installation of system 10 on a crate 64, or other location, requires no tools, and can be completed in a matter of seconds, making installation the simplest in the industry. In the arrangement shown, as one example, system 10 can be installed merely by placing system the connected feeder assembly 12 and door assembly 40 in place, and merely dropping the drop rod 50 into place.

In the arrangement shown, as one example, feeder assembly 12 can be attached or removed from door assembly 40 by dropping the feeder assembly into place within the door assembly 40. This task is completed by aligning the pins 30 of the feeder assembly within the pin hooks 44 of the door assembly 40. In this way, the feeder assembly 12 can be connected easily to the door assembly 40 with little to no tools.

Once the feeder assembly 12 is attached to the door assembly 40, the feeder system 10 is created. Feeder system 10 can then be attached to a crate 64 or any other desired location. In the arrangement shown, as one example, feeder system 10 is installed on a crate 64. In order to install feeder system 10 onto a crate 64, an installer should align the set of eyes 48 with a set of positioning holes of the horizontal plates 76. Once the eyes 48 of the frame 42 of the door assembly 40 are aligned with the positioning holes of the horizontal plates 76, the drop rod 50 or other rod should be dropped through the eyes 48 and the positioning holes. Thus, a hinged connection is created between the feeder system 10 and the crate 64.

This process should be repeated on the opposite side of the feeder system 10 in order to place the feeder system 10 in a closed position within the front 70 of crate 64. In the arrangement shown, as one example, either drop rod 50 on either side of the feeder system 10 can be removed so the feeder system 10 may swing to an open position around a vertical axis, or other axis. The drop rod 50 can be removed and reinserted as many times as necessary such that many sows may enter and exit the crate 64 without having to walk backwards out of the assembly.

In the arrangement shown, as one example, modern high volume manufacturing is used to minimize parts count, eliminate all or most welding, maximize part functionality and reduce and/or eliminate direct labor cost during manufacturing, installation and utilization. In the arrangement shown, as one example, manufacturing methods include, but are not limited to, CNC wire bending, die stamping, progressive die stamping, die forming, wire straightening, CNC laser cutting, injection molding, automatic sand casting, and robotic welding, among other automated systems. In the arrangement shown, as one example, high functional value is engineered into every component of system 10. In the arrangement shown, as one example, high engineering value is optimized for strength and minimization of the weight of every component of system 10. In the arrangement shown, as one example, cost is greatly reduced by engineering, installation and assembly methods described herein.

In the arrangement shown, as one example, once system 10 is installed and operational, livestock are moved into crate 64. Feed may be supplied to the trough 32 either before a livestock enters the crate 64 or after. Once the trough 32 contains feed, livestock may move its head through the opening 36 and eat feed therein. Additionally, livestock may drink water or other fluids from the water tree 54.

In the arrangement shown, the feeder system 10 may be cleaned by opening the door assembly 40 to an open position. However, this process may be undesired because a livestock is within the crate 64, and the cleaner (i.e., an individual cleaning the system 10) may desire to contain livestock in the crate 64 while cleaning the feeder system 10. In this way, and in the arrangement shown, as one example, a cleaner may spin the feeder assembly 12 around a horizontal axis by rotating the feeder assembly 12 on the pins 30. Thus, the interior surface 24 of the feeder assembly 12 becomes accessible to a cleaner outside of the crate 64 to clean, without creating a means of egress for the livestock confined within the confinement area 96, and/or piglets within the safety area 98.

Finally, if the trough 32 becomes empty of feed, a sensor 38 may alert and/or trigger feed is needed. In this arrangement, feed may flow from a bin and enter the trough 32 via the feed tube receptacle 28. In turn, the feed tube receptacle 28 is connected to a supply line which comes from a bin or elsewhere. The same sensor 38 or a second sensor 38 can then indicate a full level of feed which results in a hardware management system 102 to discontinue, or shut off, feed flow. In yet another arrangement, the sensor 38 may alert a user of an application 104 which can then refill the feed. In the arrangement shown, as one example, the feed is brought to the sow which reduces strain and stress on the sow, thus reducing negative interactions. Thus, the feeder system 10 can be refilled without releasing a sow, and/or refilled automatically, and/or create individualized feeding and monitoring systems or better recognition and accuracy of hog farming data.

From the above it will be appreciated that the feeder system 10 provides the following: a bio-secure feeder wherein bio-secure means reducing the potential to reduce or eliminate biological elements such as animal waste which host diseases; is easily cleaned which increases bio-security; allows for a sow to stand or lay down or feed without causing injury or death to the piglets caught between the sow and floor structural members; resists dislodging and deformation due to sow pushing, lifting, or gnawing on the structure; resists dislodging and deformation due to body weight and rubbing forces; provides some flex in the system to accommodate the pushing created by the animals without impacting the long-term structure and/or structural integrity of the system; feeds hogs and/or other livestock in a singular and/or plural orientation; prevents injury to hog or staff members; allows for proper ventilation; allows for vertical discharge of waste to the pit without potential for entrapment; does not damage sow facial features or other parts; reduces assembly tools required and/or eliminates the need for assembly tools for onsite assembly or disassembly; utilizes manufacture systems for high production and/or automated processes; optimizes the production cost to primarily materials and equipment depreciation; optimizes or eliminates labor cost; reduces the per crate shipping weight; reduces assembly stack up error associated with welding; minimizes the total unique part count per assembly; minimizes tools required for assembly; minimizes raw material geometric shapes; illustrates a feeding system; illustrates an assembly of feeding systems and farrowing crates in a barn; illustrates assembly and integration of a plurality of feeding systems; illustrates assembly and integration of feeding systems; among countless other advantages and improvements.

It will be appreciated by those skilled in the art that other various modifications could be made to the system without parting from the spirit and scope of this disclosure. All such modifications and changes fall within the scope of the disclosure and the claims and are intended to be covered thereby.

What is claimed:

1. A feeder system, comprising:
a feeder assembly;
wherein the feeder assembly is configured to provide food to livestock;
a door assembly;
the door assembly having a frame;
wherein the frame of the door assembly is configured to operatively connect to the feeder assembly.

2. The system of claim 1, further comprising:
wherein the door assembly is operatively connected to a crate.

3. The system of claim 1, further comprising:
a feed tube receptacle;
wherein the feed tube receptacle is configured to connect to a feed delivery system to receive feed.

4. The system of claim 1, further comprising:
at least one pin;
wherein the at least one pin is configured to operably connect the feeder assembly to the door assembly.

5. The system of claim 1, further comprising:
a flange;
wherein the flange is configured to connect a set of opposing sidewalls of the feeder assembly.

6. The system of claim 1, further comprising:
a sensor;
wherein the feeder assembly comprises a trough;
wherein the sensor is configured to detect a level of feed within the trough.

7. The system of claim 1, further comprising:
at least one pin;
wherein the at least one pin is configured to operably connect the feeder assembly to the door assembly;
at least one pin hook;
wherein the at least one pin hook is configured to receive the at least one pin therein.

8. The system of claim 1, further comprising:
the feeder assembly having a trough;
wherein the trough is formed of a sidewall;
wherein the trough is configured to hold feed.

9. The system of claim 1, further comprising:
at least one nursery panel;
wherein the at least one nursery panel is configured to contain at least one livestock within the system;
wherein the at least one livestock is a nursing offspring.

10. The system of claim 1, further comprising:
a crate;
a confinement area;
wherein the crate is configured to confine at least one livestock in the confinement area;
wherein the feeder assembly is operatively connected to the crate;
wherein the at least one livestock is a nursing adult.

11. The system of claim 1, further comprising:
a crate having at least one Flying-W;
a confinement area;
wherein the crate is configured to confine at least one livestock in the confinement area.

12. The system of claim 1, further comprising:
a crate;
a confinement area;
a safety area;
wherein the feeder assembly is configured to provide feed to at least one livestock contained within the confinement area.

13. The system of claim 1, further comprising:
a crate;
a confinement area;
a water tree;
wherein the water tree is configured to provide fluid to at least one livestock contained within the confinement area.

14. The system of claim 1, further comprising:
a crate;
a safety area;
a water tree;
wherein the water tree is configured to provide fluid to at least one livestock contained within the safety area.

15. The system of claim 1, further comprising:
a crate;
a safety area;
a heat lamp;
wherein the heat lamp is configured to provide warmth to livestock contained within the safety area.

16. The system of claim 1, further comprising:
at least one sensor configured to detect at least one environmental condition of the system.

17. The system of claim 1, further comprising:
a hardware management system configured to respond to a data input and cause an output.

18. The system of claim 1, further comprising:
an application;
wherein the application is installed on an electronic device and controlled via a user interface;
wherein the application is wirelessly connected to a hardware management system and configured to wirelessly control the hardware management system.

19. The system of claim 1, further comprising:
a bio-waste containment pit;
a confinement area;
wherein the containment pit is positioned below the confinement area such that bio-mass pass into the containment pit.

20. The system of claim 1, further comprising:
a floor deck assembly comprised of at least one floor beam and at least one stiffener and at least one floor plate.

21. The system of claim 1, further comprising:
a containment pit;
wherein the contaminant pit includes a bottom and a sidewall.

22. A feeder system, comprising:
a feeder assembly;
a door assembly;
a crate having at least one Flying-W, at least one horizontal plate, at least one center plate, and at least one end rod;
a confinement area;
a safety area;
at least one pin;
wherein the at least one pin is configured to operably connect the feeder assembly to the door assembly;
wherein the feeder assembly is configured to provide feed to livestock contained within the confinement area.

23. A feeder system, comprising:
a feeder assembly wherein the feeder assembly is fabricated from a pair of stamped sections;
a feed tube receptacle;
a flange;
wherein the feeder assembly is jointed at a common flange surface in opposing directions;
wherein the feeder assembly accessibility hole is cut prior to assembly;
wherein the feed tube receptacle captures the flange and assembly seam.
